(19) United States
(12) Patent Application Publication
(10) Pub. No.: US 2006/0047016 A1
(43) Pub. Date: Mar. 2, 2006

(54) Method of making a three-dimensional decorative article

(76) Inventor: Adrian Trevor Wolman, Fresnaye (ZA)

Correspondence Address: Ladas & Parry LLP, 26 West 61st Street, New York, NY, 10023, US

(21) Appl. No.: 10/932,449

(22) Filed: Sep. 2, 2004

(51) Int. Cl. C03C 17/00; C09D 11/00

(52) U.S. Cl. 523/160; 427/372.2; 523/161

(57) ABSTRACT

A method of making a three-dimensional decorative article such as a sign, is provided. Said method comprises applying a solvent-based ink composition to a surface of a thermo-formable plastic sheet in a digital flatbed printer, allowing solvent to evaporate from the applied ink so that the ink adheres to the surface, and forming the plastic sheet to have a three-dimensional shape.

### FIELD OF THE INVENTION

This invention relates to the making of three-dimensional decorative objects, such as signs, with high quality graphics printed thereon.

### BACKGROUND OF THE INVENTION

Three-dimensional signs that include protruding and recessed parts, e.g. a relief, are often produced by vacuum forming a polymeric sheet, but if the three dimensional sign has to be coloured, the colour has to be applied after vacuum forming and owing to the three dimensional shape, the colour cannot be simply applied, but parts of the polymeric sheet have to be masked, while colours are applied in turn. These processes of applying colour are time and labour intensive and therefore costly and do not allow complex graphics to be printed on the signs.

High quality graphics are presently printed onto polymeric sheets to provide signs or other decorative articles, but the ink compositions used for printing are not solvent based, but have to be cured in atmosphere, so that underlying layers of the ink compositions that adhere to the polymeric sheets are cut off from the atmosphere by upper layers and do not cure sufficiently to bond to the polymeric sheet to the extent to allow it to be formed into a three dimensional shape, e.g. by vacuum forming. Further, in an attempt to get the ink compositions to bond to the polymeric sheets, the surfaces of the polymeric sheets are often treated to increase its surface roughness.

It is an object of the invention to provide a cost effective method of making three dimensional decorative articles such as signs, with high quality graphics printed thereon.

### SUMARY OF THE INVENTION

According to the invention there is provided a method of making a three-dimensional decorative article, said method comprising:

applying a solvent-based ink composition to a surface of a thermo-formable plastic sheet;

allowing solvent to evaporate from the applied ink composition so that the ink composition adheres to the surface; and

forming the plastic sheet to have a three-dimensional shape.

The solvent-based ink composition may be applied to the plastic sheet by printing in a flatbed printer such as a digital flatbed printer.

The ink composition may include the following, by mass:

pigment: 2 to 4 percent;

thermoplastic resin: 3 to 8 percent; and

solvent: 85 to 92 percent,

and the solvent may include an ester solvent and/or a ketone solvent.

The plastic sheet may be of an acrylic polymer, such as Perspex, or the like.

The invention extends to the ink composition for use in the method as described hereinabove and to a three-dimensional decorative article that has been made in accordance with the method.

### BRIEF DESCRIPTION OF THE DRAWINGS

Preferred embodiments of the invention are described with reference to the drawings wherein:

FIG. 1 is a three-dimensional view of a printer applying an ink composition to a sheet, in accordance with the invention;

FIG. 2 is a three-dimensional view of the sheet of FIG. 1 in a vacuum forming machine; and

FIG. 3 is a three-dimensional view of the sheet of FIGS. 1 and 2 after it has been formed in the vacuum forming machine of FIG. 2.

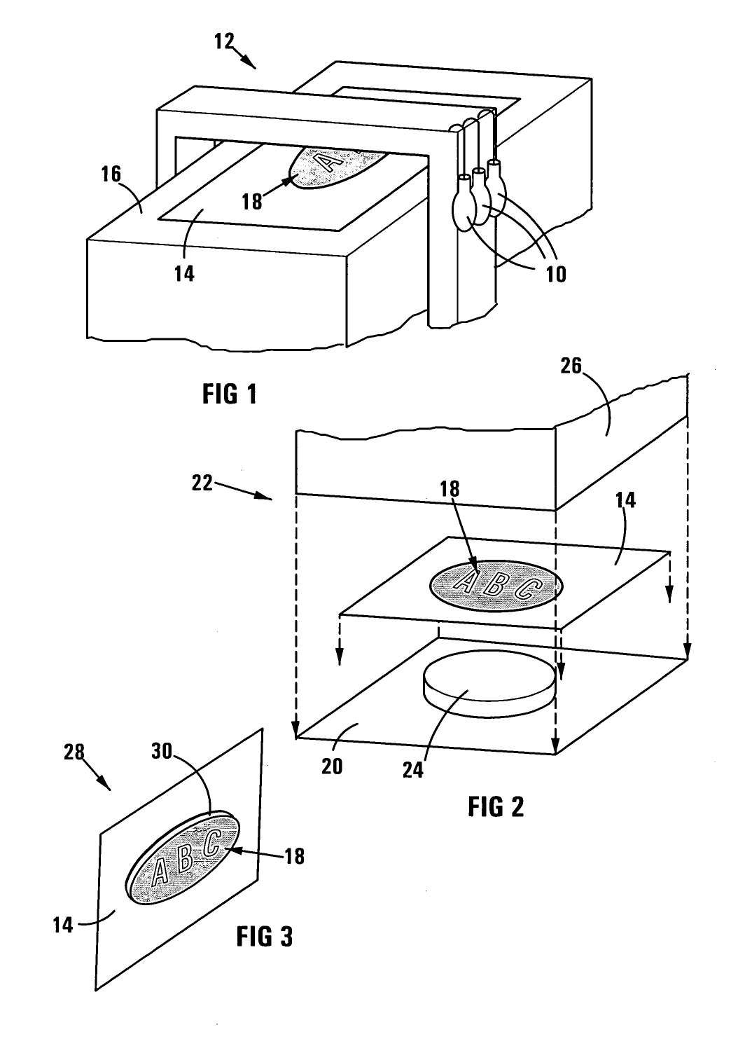

### DETAILED DESCRIPTION OF PREFERRED EMBODIMENTS

A number of solvent-based ink compositions in accordance with the invention are prepared by combining at least the following ingredients in the following percentages, by mass:

| | |
|---|---|
| pigment | 2 to 4 percent; |
| thermoplastic resins | 3 to 8 percent; and |
| solvent: | 85 to 92 percent. |

The solvent can be a blend of one of more ester solvents and/or ketone solvents, such as acetone. The ink compositions are poured into suitable containers such as bottles 10 that and connected to a flatbed digital printer 12.

A flat sheet 14 of a thermo-formable plastic such as an acrylic polymer, e.g. Perspex, is placed generally horizontally on the bed 16 of the printer 12 and a graphic image 18 is printed on the surface of the Perspex sheet 14 facing upwards, by applying the ink compositions via the printing head of the printer. Perspex is a suitable acrylic polymer and is commonly used for its transparent or translucent properties, to make decorative articles such as signs that can be back-lit.

The ink compositions of the graphic image 18 is allowed to dry, i.e. the solvents are allowed to evaporate from the ink compositions, so that the ink adheres sufficiently to the surface of the Perspex sheet 14 to allow it to be handled, without damaging the graphic image.

The Perspex sheet 14 with its dry, printed graphic image 18 is placed on a bed 20 of a vacuum forming machine 22, with suitable protuberances 24 extending from the bed 20. In FIG. 2 a single protuberance 24 is shown that is generally in register with the graphic image 18, but it is to be understood that a wide variety of protuberances of varying shapes and sizes can be used.

A lid 26 of the vacuum forming machine 22 is closed and the sheet 14 is vacuum formed in the conventional manner, to give the sheet a three dimensional shape, thus providing a three dimensional sign 28 with a protuberance 30 corresponding to the shape of the protuberance 24 and generally in register with the graphic image 18.

The invention described allows high quality graphic images 18 to be printed on polymeric sheets 14 that can be vacuum formed, to provide three-dimensional decorative articles, such as signs 28, at low cost.

Although preferred embodiments of the invention are described herein in detail, it will be understood by those skilled in the art that variations may be made thereto without departing from the spirit of the invention of the scope of the appended claims.

We claim:

1. A method of making a three-dimensional decorative article, said method comprising:
applying a solvent-based ink composition to a surface of a thermo-formable plastic sheet;
allowing solvent to evaporate from the applied ink so that the ink adheres to the surface; and
forming the plastic sheet to have a three-dimensional shape.

2. A method as claimed in claim 1, wherein the ink composition is applied to the plastic sheet by printing in a flatbed printer.

3. A method as claimed in claim 2, wherein the printer is a digital printer.

4. A method as claimed in claim 1, wherein the ink composition includes the following, by mass:

| | |
|---|---|
| pigment: | 2 to 4 percent; |
| thermoplastic resin: | 3 to 8 percent; and |
| solvent: | 85 to 92 percent. |

5. A method as claimed in claim 4, wherein the solvent includes at least one of an ester solvent and a ketone solvent.

6. A method as claimed in claim 1, wherein the plastic sheet is of an acrylic polymer.

7. An ink composition for use in a method as claimed in claim 4, said ink composition including the following, by mass:

| | |
|---|---|
| pigment: | 2 to 4 percent; |
| thermoplastic resin: | 3 to 8 percent; and |
| solvent: | 85 to 92 percent. |

8. An ink composition as claimed in claim 7, wherein the solvent includes at least one of an ester solvent and a ketone solvent.

9. A three dimensional three-dimensional decorative article that has been made in accordance with a method as claimed in claim 1.
